(19) United States
(12) Patent Application Publication
(10) Pub. No.: US 2024/0420391 A1
(43) Pub. Date: Dec. 19, 2024

(54) INTELLIGENT DASHBOARD SEARCH ENGINE

(71) Applicant: The Toronto-Dominion Bank, Toronto (CA)

(72) Inventors: SAGAR N. PURKAYASTHA, Calgary (CA); Faran Mahboubi, Toronto (CA); Jingjing Liu, Toronto (CA); Jingwen Li, Toronto (CA)

(21) Appl. No.: 18/336,721

(22) Filed: Jun. 16, 2023

(51) Int. Cl. G06T 11/20; G06F 16/242; G06F 16/248

(52) U.S. Cl. CPC G06T 11/206; G06F 16/243; G06F 16/248

(57) ABSTRACT

The present disclosure generally relates to systems, software, and computer-implemented methods for an intelligent dashboard search engine. One example method includes obtaining, for each dashboard of a plurality of dashboards, textual data for the dashboard. Word embeddings are generated for a portion of the textual data for each dashboard. A dashboard search query is received and word embeddings are generated of a portion of the text in the dashboard search query. The word embeddings for the dashboard search query are compared to the word embeddings for each dashboard to generate a respective similarity score for each dashboard. Information about at least one matching dashboard is provided, in response to the dashboard search query, based on the generated similarity scores for the plurality of dashboards.

### TECHNICAL FIELD

The present disclosure generally relates to data processing techniques and provides computer-implemented methods, software, and systems for an intelligent dashboard search engine.

### BACKGROUND

A dashboard can be used to display summary information for different sets of related information in a single user interface. A dashboard can include one or more visualizations such as tables, graphs, or charts to enable users, including users not intimately familiar with underlying data of the visualizations, to view summaries or conclusions from the data. Dashboards can be designed to provide answers to which key users of an organization are interested.

### SUMMARY

The present disclosure generally relates to systems, software, and computer-implemented methods for an intelligent dashboard search engine.

A first example method includes: obtaining, for each dashboard of a plurality of dashboards, textual data for the dashboard; for each dashboard, generating word embeddings of a portion of the textual data for the dashboard; receiving a dashboard search query for searching for dashboards that relate to text in the dashboard search query; generating word embeddings of a portion of the text in the dashboard search query; comparing the word embeddings of the portion of the text in the dashboard search query to the word embeddings of the textual data for each dashboard to generate a respective similarity score for each dashboard representing a degree of match between the word embeddings of the portion of the textual data for the dashboard and the word embeddings of the portion of the text in the dashboard search query; and providing, in response to the dashboard search query, information about at least one matching dashboard based on the generated similarity scores for the plurality of dashboards.

Implementations can optionally include one or more of the following features.

The similarity score for a dashboard can be based on a determined distance in a vector space between word embeddings of words of the search query and word embeddings of words in the textual data for the dashboard. The information about the at least one matching dashboard can be provided based on aggregate determined distances between word embeddings of words of the search query and word embeddings of the textual data of the at least one matching dashboard. The distance between a word embedding of a search query word and a word embedding of a word in the textual data for a dashboard can represent a distance in the vector space between the word embedding for the word in the textual data for the dashboard and the word embedding of the search query word. The distance can be determined using a word mover distance algorithm. The word mover distance algorithm can use a Euclidean distance metric, a Manhattan distance metric, or some other type of distance metric. The textual data for a first dashboard can include metadata for the first dashboard. The textual data for a first dashboard can include user-provided content regarding at least one visual included in the first dashboard. The user-provided content for a first visual of the first dashboard can include a natural language question that encapsulates content of the first visual. Stop words can be removed from the dashboard search query before generating word embeddings of the portion of the text in the dashboard search query. Stop words can be removed from the textual data of a first dashboard before generating word embeddings of the portion of the textual data of the first dashboard. Providing information about at least one matching dashboard based on the similarity scores of respective dashboards can include ranking dashboards based on similarity scores and providing information about a set of highest-ranked dashboards. Providing information about a first matching dashboard can include providing a link, that when selected, provides access to the first matching dashboard.

Similar operations and processes associated with each example system can be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations can also be contemplated. Additionally, similar operations can be associated with or provided as computer-implemented software embodied on tangible, non-transitory media that processes and transforms the respective data, some or all of the aspects can be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. First, relevant dashboard search results can be returned more quickly as compared to other search engine approaches that parse and evaluate dashboard contents at runtime. Second, providing of relevant dashboard search results can result in resource savings due to fewer searches being performed as compared to other systems that generate less-relevant results. With other systems, a higher number of search queries are submitted, e.g., over a network, due to users receiving less-relevant and unsatisfactory results, and more processing time is spent generating a higher number of less-relevant results for the higher number of search queries, as compared to the intelligent dashboard search query engine described herein. Third, relevant dashboard search results can be provided to users who may not be aware of dashboard content or metadata about available dashboards. Fourth, search results can be identified and returned, for example, even when a user search query doesn't exactly match dashboard content or metadata. Fifth, relevant dashboard search results can be provided to internal users of an organization even when user search traffic is sparse as compared to other search engines that serve large external user bases. The other search engines may require a substantial historic search volume to train models before achieving a satisfactory accuracy, for example.

### DESCRIPTION OF DRAWINGS

FIG. 1 is a block diagram of a networked environment for dashboard retrieval and utilization.

FIG. 2 is a block diagram of a dashboard search engine.

FIG. 3 is a diagram that illustrates example dashboard data for an example dashboard.

FIG. 4 illustrates an example dashboard search engine user interface.

FIG. 5 is a diagram that illustrates aspects of an example word mover distance algorithm.

FIG. 6 illustrates an example dashboard search engine.

FIG. 7 is a flow diagram of an example method for generating and providing dashboard search results.

### DETAILED DESCRIPTION

The present disclosure generally relates to an intelligent dashboard search engine for finding dashboards that match a dashboard search query. As mentioned above, a dashboard can be used to display summary information from different sets of related information in one user interface using, for example, one or more visualizations such as tables, graphs, or charts. Dashboards may be available to internal users of an organization and/or generally publicly available to users. As one example, a financial institution may have hundreds of dashboards that present different types of financial or other information. Additionally, development of new dashboards may be an ongoing activity in the organization. As the number of dashboards increases, an amount of information overload also increases whereby a given user's awareness of the existence of a given dashboard or knowledge of how to find the dashboard decreases. Accordingly, users may be unable to find a certain dashboard or may not be aware that certain dashboards exist. Therefore, users may not be able to readily find and consume particular dashboards with information that is relevant to their queries.

As summarized here and described in more detail below, the dashboard search engine can generate word embeddings from the dashboard search query and compare the word embeddings generated from the dashboard query to previously-generated word embeddings of dashboard information of candidate dashboards that may match the dashboard search query, to identify, from the candidate dashboards, dashboards that are most similar to the dashboard search query.

Use of the intelligent dashboard search engine can achieve various significant technical advantages and efficiencies. For example, relevant search results can be returned more quickly and with less resources as compared to other search engine approaches that may parse and evaluate dashboard contents in response to receiving a search query. Additionally, providing of relevant search results can result in resource savings due to fewer searches being performed as compared to other search engine systems that generate less-relevant results. As another example, relevant dashboard search results can be provided to users without a user having to be aware of keywords that may have been assigned to dashboards of interest to the users. As yet another example, relevant search results can be provided to internal users of an organization even when user search traffic is sparse as compared to other search engines that serve large external user bases. The other search engines may require a substantial historic search volume to train models before achieving a satisfactory accuracy, for example.

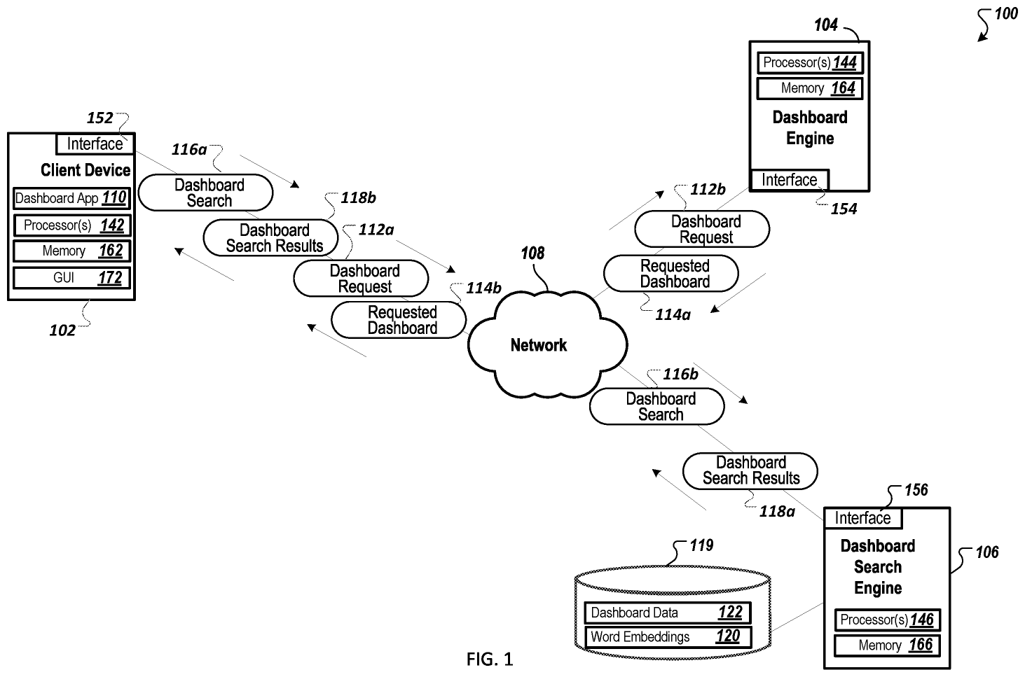

Turning to the illustrated example implementation, FIG. 1 is a block diagram of a networked environment 100 for dashboard retrieval and utilization. As further described with reference to FIG. 1, the environment 100 implements various systems that interoperate to provide intelligent searching for dashboards that match a dashboard search query.

As shown in FIG. 1, the example environment 100 includes a client device 102, a dashboard engine 104, a dashboard search engine 106, and a network 108. Although shown as separate engines, in some implementations, the dashboard search engine 106 is part of the dashboard engine 104. The function and operation of each of these components is described below.

A dashboard application 110 running on the client device 102 can submit a dashboard request 112a over the network 108 to the dashboard engine 104. The dashboard application 110 can be an application running in a web browser, a web page, or a native application native to the client device 102. The dashboard request 112a can correspond to user selection of a link to a certain dashboard that is displayed in the dashboard application 110. As another example, the dashboard request 112a can be or include a dashboard name or a dashboard identifier of a requested dashboard.

The dashboard engine 104 can receive the dashboard request 112a as a dashboard request 112b. The dashboard engine 104 can retrieve or generate dashboard information for the requested dashboard and provide requested dashboard information 114a to the client device 102 over the network 108 in response to the dashboard request 112a.

The client device 102 can receive the requested dashboard information 114a as requested dashboard information 114b over the network 108. The client device 102 can use the requested dashboard information 114b to the display the requested dashboard (e.g., in the dashboard application 110).

As mentioned, the user of the client device 102 may not be aware of how many or which dashboards are available, or how to retrieve a given dashboard. For instance, a user may not know how to find a dashboard that has information about a certain metric or that presents a certain visual. Additionally, a number of potentially available dashboards may be overwhelming to a user, due to a sheer volume of dashboards that may exist in a dashboard hierarchy (e.g., where a given dashboard may be a sub-dashboard of another dashboard and may have one or more sub-dashboards).

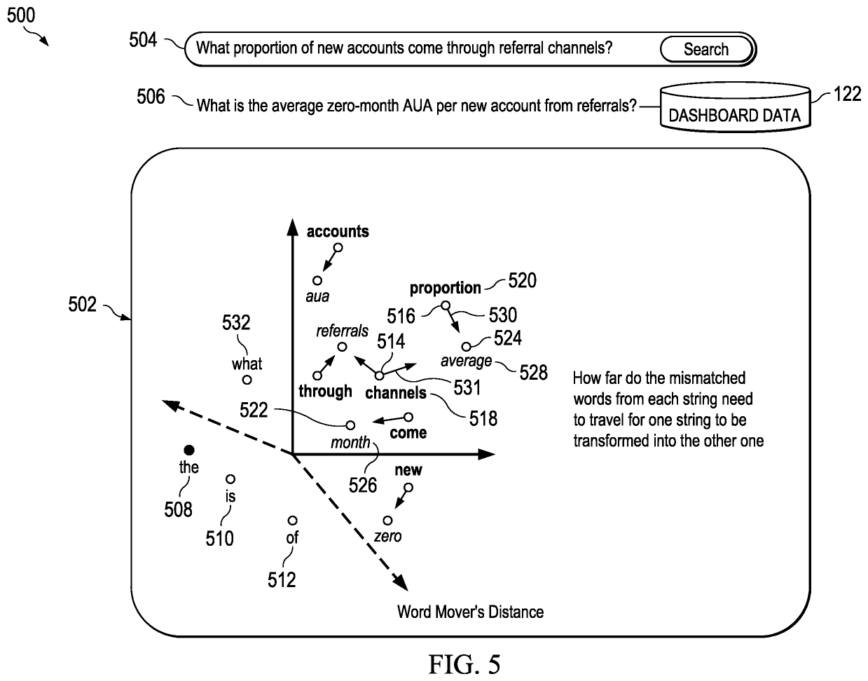

Accordingly, the dashboard application 110 (and/or another application or interface) can include a dashboard search option that enables a user of the client device 102 to enter a dashboard search query for searching for available dashboards that correspond to the dashboard search query. For example, the client device 102 can send a dashboard search query 116a to the dashboard search engine 106, over the network 108. The dashboard search engine 106 can receive the dashboard search query 116a as a dashboard search query 116b. The dashboard search engine 106 can generate dashboard search results 118a that match and/or are identified and generated in response to the dashboard search query 116b. The dashboard search engine 106 can provide the dashboard search results 118a to the client device 102, over the network 108, in response to the dashboard search query 116a. The client device 102 can receive the dashboard search results 118a as dashboard search results 118b and the dashboard search results 118b can be presented in the dashboard application 110, to enable the user to select and navigate to a given dashboard included in the dashboard search results 118b that matches and/or has been identified in response to the dashboard search query 116a. Example dashboard search results are described in more detail below with respect to FIG. 5.

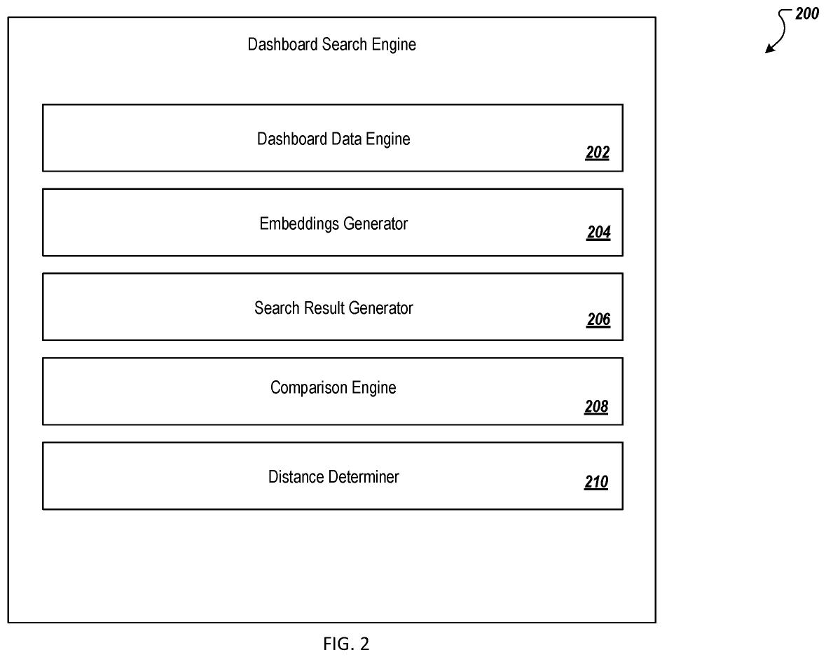

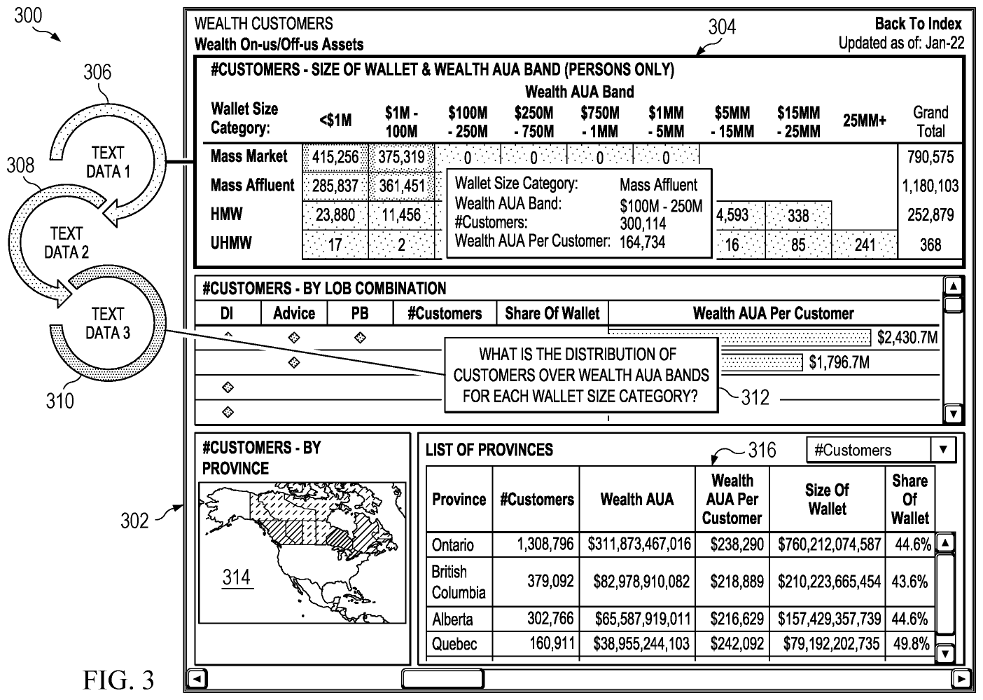

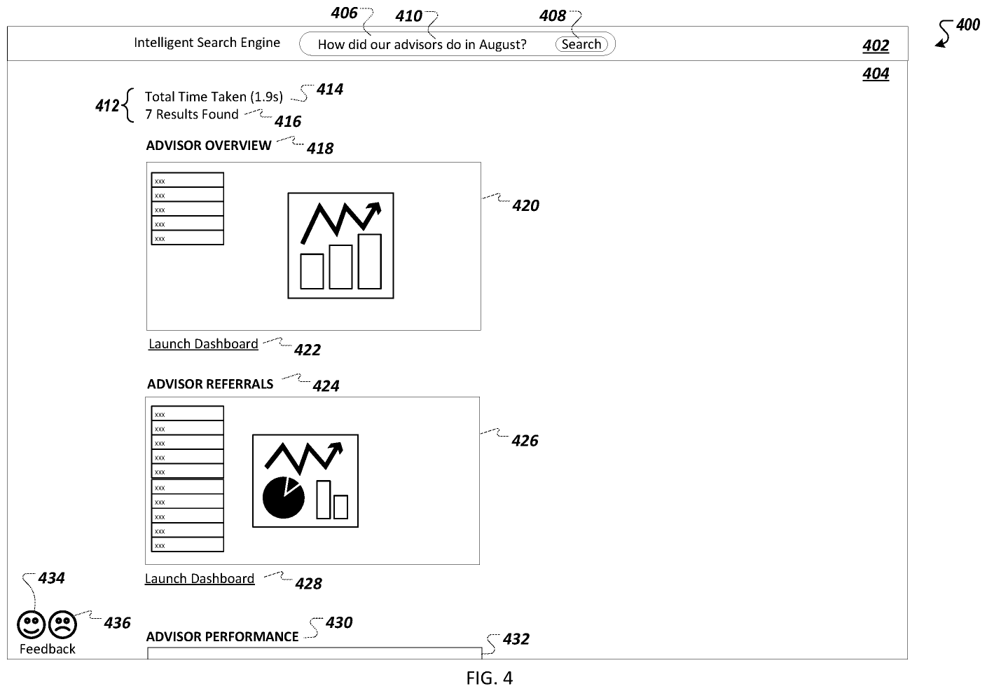

In further detail regarding generation of the dashboard search results 118a, the dashboard search engine 106 can, for each of multiple candidate dashboards, retrieve, from a repository 119, word embeddings 120 associated with the candidate dashboard, where the word embeddings 120 for the candidate dashboard have been generated by the dashboard search engine 106 (or another engine) based on dashboard data 122 for the candidate dashboard. Dashboard data 122 for a dashboard, as described in more detail below with respect to FIG. 2 and FIG. 3, can be textual metadata about the dashboard, such as metadata about visuals of a dashboard that is user-provided and/or automatically generated. Word embeddings 120, which are described in more detail below with respect to FIG. 2 and FIG. 4, are numerical representations of at least a portion of the dashboard data 122.

The dashboard search engine 106 can generate search query word embeddings based on the dashboard search query 116b and compare the word embeddings 120 for each candidate dashboard to the search query word embeddings to generate a similarity score for each candidate dashboard that represents a degree of match between the word embeddings 120 for the candidate dashboard and the search query word embeddings. For example, the dashboard search engine 106 can use a word mover distance algorithm to determine the similarity scores. Similarity scores, the word mover distance algorithm, and other aspects of the dashboard search engine 106 are described in more detail below with respect to FIGS. 2 and 4.

The dashboard search engine 106 can generate the dashboard search results 118a based on the similarity scores. For example, dashboard information (e.g., a dashboard name, a dashboard description, and a link to the dashboard) can be included in the dashboard search results 118a for candidate dashboards that have most-similar similarity scores (e.g., the highest score or the top-n scores indicating the n dashboards with corresponding similarity scores that are higher than scores for other dashboards). For example, the dashboard search results 118a can include dashboard information for a predetermined number of dashboards with most-similar similarity scores or for dashboards that have a similarity score above or below a predetermined threshold similarity score.

As used in the present disclosure, the term “computer” is intended to encompass any suitable processing device. For example, the client device 102, the dashboard engine 104, and the dashboard search engine 106 can be any computer or processing devices such as, for example, a blade server, general-purpose personal computer (PC), Mac®, workstation, UNIX-based workstation, or any other suitable device. Moreover, although FIG. 1 illustrates a single client device 102, a single dashboard engine 104, and a single dashboard search engine 106, the environment 100 can be implemented using a single system or more than those illustrated, as well as computers other than servers, including a server pool. In other words, the present disclosure contemplates computers other than general-purpose computers, as well as computers without conventional operating systems.

Similarly, the client device 102 can be any system that can request data and/or interact with the dashboard engine 104 and the dashboard search engine 106. The client device 102, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client device 102 can include, as discussed, the dashboard application 110 and one or more web browsers or web applications that can interact with particular applications executing remotely from the client device 102, such as applications on the dashboard engine 104 and/or dashboard search engine 106, among others.

As illustrated, the client device 102, the dashboard engine 104, and the dashboard search engine 106 respectively include processor(s) 142, 144, or 146. In some cases, multiple processors can be used according to particular needs, desires, or particular implementations of a respective device included in the environment 100. Each processor of the processor(s) 142, 144, and 146 can be a central processing unit (CPU), an application specific integrated circuit (ASIC), a field-programmable gate array (FPGA), or another suitable component. Generally, each processor of the processor(s) 142, 144, and 146 executes instructions and manipulates data to perform the operations of the respective corresponding computing device. Specifically, the processor(s) 142, 144, and 146 can execute the algorithms and operations described in the illustrated figures, as well as the various software modules and functionality described herein. Each processor of the processor(s) 142, 144, and 146 can have a single or multiple cores, with each core available to host and execute an individual processing thread. Further, the number of, types of, and particular processors used to execute the operations described herein can be dynamically determined based on a number of requests, interactions, and operations associated with the environment 100.

Interface 152, 154, and 156 of client device 102, the dashboard engine 104, and the dashboard search engine 106 can be used for communicating with other systems in a distributed environment-including within the environment 100-connected to the network 108. Generally, each interface 152, 154, or 156 comprises logic encoded in software and/or hardware in a suitable combination and operable to communicate with the network 108 and other components. More specifically, each interface 152, 154, or 156 can comprise software supporting one or more communication protocols associated with communications such that the network 108 and/or interface's hardware is operable to communicate physical signals within and outside of the illustrated environment 100. Still further, each interface 152, 154, or 156 can allow the client device 102, the dashboard engine 104, or the dashboard search engine 106, respectively, and/or other portions illustrated within the environment 100 to perform the operations described herein.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including, e.g., C, C++, JavaScript, Java™, Visual Basic, assembler, Perl®, any suitable version of 4GL, as well as others.

As illustrated, the client device 102, the dashboard engine 104, and the dashboard search engine 106 respectively include memory 162, 164, or 166. Each memory 162, 164, or 166 can represent a single memory or multiple memories. Each memory 162, 164, or 166 can include any memory or database module and can take the form of volatile or non-volatile memory including, without limitation, magnetic media, optical media, random access memory (RAM), read-only memory (ROM), removable media, or any other suitable local or remote memory component. Each memory 162, 164, or 166 can store various objects or data associated with the respective corresponding computing device, including any parameters, variables, algorithms, instructions, rules, constraints, or references thereto.

Network 108 facilitates wireless or wireline communications between the components of the environment 100 (e.g., between the client device 102, the dashboard engine 104, and the dashboard search engine 106), as well as with any other local or remote computers, such as additional mobile devices, clients, servers, or other devices communicably coupled to network 108, including those not illustrated in FIG. 1. In the illustrated environment, the network 108 is depicted as a single network, but can be comprised of more than one network without departing from the scope of this disclosure, so long as at least a portion of the network 108 can facilitate communications between senders and recipients. In some instances, one or more of the illustrated components (e.g., the dashboard engine 104 and/or the dashboard search engine 106) can be included within or deployed to network 108 or a portion thereof as one or more cloud-based services or operations. The network 108 can be all or a portion of an enterprise or secured network, while in another instance, at least a portion of the network 108 can represent a connection to the Internet. In some instances, a portion of the network 108 can be a virtual private network (VPN). Further, all or a portion of the network 108 can comprise either a wireline or wireless link. Example wireless links can include 802.11a/b/g/n/ac, 802.20, WiMax, LTE, and/or any other appropriate wireless link. In other words, the network 108 encompasses any internal or external network, networks, sub-network, or combination thereof operable to facilitate communications between various computing components inside and outside the illustrated environment 100. The network 108 can communicate, for example, Internet Protocol (IP) packets, Frame Relay frames, Asynchronous Transfer Mode (ATM) cells, voice, video, data, and other suitable information between network addresses. The network 108 can also include one or more local area networks (LANs), radio access networks (RANs), metropolitan area networks (MANs), wide area networks (WANs), all or a portion of the Internet, and/or any other communication system or systems at one or more locations.

As illustrated, one or more client devices 102 can be present in the example environment 100. Although FIG. 1 illustrates a single client device 102, multiple clients can be deployed and in use according to the particular needs, desires, or particular implementations of the environment 100. Each client device 102 can be associated with a particular user (e.g., a user who may acquire an item via interactions with the client device 102), or can be associated with/accessed by multiple users, where a particular user is associated with a current session or interaction at the client device 102. The client device 102 can be a client device at which the user is linked or associated.

The illustrated client device 102 is intended to encompass any computing device, such as a desktop computer, laptop/notebook computer, mobile device, smartphone, personal data assistant (PDA), tablet computing device, one or more processors within these devices, or any other suitable processing device. In general, the client device 102 and its components can be adapted to execute any operating system. In some instances, the client device 102 can be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the client device 102. Such information can include digital data, visual information, or a GUI (Graphical User Interface) 172, as shown with respect to the client device 102. Specifically, the client device 102 can be any computing device operable to communicate with the dashboard engine 104, the dashboard search engine 106, other client(s), and/or other components via network 108, as well as with the network 108 itself, using a wireline or wireless connection. In general, the client device 102 comprises an electronic computer device operable to receive, transmit, process, and store any appropriate data associated with the environment 100 of FIG. 1.

The dashboard application 110 executing on the client device 102 can be or include any suitable application, program, mobile app, or other component. The dashboard application 110 can interact with the dashboard engine 104, the dashboard search engine 106, and/or other client(s), or portions thereof, via network 108. In some instances, the dashboard application 110 can be a web browser, where the functionality of the dashboard application 110 can be realized using a web application or website that the user can access and interact with via the dashboard application 110. In other instances, the dashboard application 110 can be a remote agent, component, or client-side version of a corresponding server application provided by the dashboard engine 104 or the dashboard search engine 106. In some instances, the dashboard application 110 can interact directly or indirectly (e.g., via a proxy server or device) with the dashboard engine 104 and/or the dashboard search engine 106 or portions thereof. As described above, the dashboard application 110 can be used to view or interact with dashboards and/or dashboard search results.

The GUI 172 of the client device 102 interfaces with at least a portion of the environment 100 for any suitable purpose, including generating a visual representation of the dashboard application 110 and/or a web browser, for example. For instance, the GUI 172 can be used to present screens and information associated with the dashboard engine 104 and/or the dashboard search engine 106 (e.g., one or more interfaces including or representing dashboards and/or dashboard search results) and interactions associated therewith. The GUI 172 can also be used to view and interact with various web pages, applications, and web services located local or external to the client device 102. Generally, the GUI 172 provides the user with an efficient and user-friendly presentation of data provided by or communicated within the system. The GUI 172 can comprise a plurality of customizable frames or views having interactive fields, pull-down lists, and buttons operated by the user. In general, the GUI 172 is often configurable, supports a combination of tables and graphs (bar, line, pie, status dials, etc.), and is able to build real-time portals, application windows, and presentations. Therefore, the GUI 172 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software can instead include a number of sub-modules, third-party services, components, libraries, and such, as appropriate. Conversely, the features and functionality of various components can be combined into single components as appropriate.

FIG. 2 is a block diagram of a dashboard search engine 200. As used herein, the term “engine” refers to a set of programming instructions that, when implemented by a processing device, results in performance of a task or a set of tasks. The dashboard search engine 200 includes a dashboard data engine 202. The dashboard data engine 202 can obtain textual data for each dashboard of a plurality of dashboards. For example, the dashboard data engine 202 can obtain, as the dashboard data 122, textual data for each dashboard provided by the dashboard engine 104 of FIG. 1. The dashboard data engine 202 can manage dashboard data (e.g., the dashboard data 122) over time. For example, the dashboard data engine 202 can be configured to obtain new dashboard data for a newly-added dashboard recently made available by the dashboard engine 104 and add the new dashboard data to the dashboard data 122 in the repository 119. As another example, the dashboard data engine 202 can remove dashboard data from the repository 119 for dashboards that are no longer provided by the dashboard engine 104 (or that are otherwise no longer unavailable to users of the system 100).

Dashboard data 122 obtained by the dashboard data engine 202 for a dashboard can include textual data regarding visuals included in the dashboard. For instance, the dashboard data engine 202 can obtain one or more sets of textual data for each visual included in the dashboard. Dashboard data 122 obtained by the dashboard data engine 202 for a dashboard can be metadata for the dashboard. Metadata for the dashboard can be automatically generated textual content for the dashboard and/or metadata provided by users (e.g., by creator of dashboards or administrators responsible for managing the dashboard). For instance, metadata for a dashboard visual can be user-provided content regarding the visual. In some implementations, the user-provided content for a visual of a dashboard is a natural language question that encapsulates content of the visual. User-provided content can be provided by domain experts, for example.

As another example, the textual data for visuals of a dashboard can be automatically generated by a generative AI (Artificial Intelligence) engine included in the dashboard data engine 202. For instance, the generative AI engine can be trained to generate textual data (e.g., as natural language questions) that encapsulate content of a visual based on a training set of metadata initially created by domain experts (or by another system). Once trained, the generative AI engine can automatically generate and provide textual metadata for each visual of a dashboard.

FIG. 3 is a diagram 300 that illustrates example dashboard data for an example dashboard 302. The dashboard data engine 202 can retrieve, for example, dashboard data for each of multiple candidate dashboards that are evaluated as potential matches for (and/or responses to) a dashboard search query. In some implementations, dashboard data is retrieved for visuals of a dashboard. For example, the dashboard 302 includes a visual 304 (among other visuals). The visual 304 is a table that depicts customer counts by different wallet size and wealth AUA (Assets Under Administration) combinations.

The dashboard data engine 202 can retrieve multiple sets of dashboard data (e.g., first dashboard data 306, second dashboard data 308, and third dashboard data 310) for the visual 304. For instance, the third dashboard data 310 can be a question 312 of “What is the distribution of customers over wealth AUA bands for each wallet size category?” The question 312 may represent a meaning of the visual 304 posed as a question (e.g., where the visual 304 could be an answer (or provide an answer) to the question 312). As mentioned, the question 312 may have been generated by machine learning or by a human expert familiar with the visual 304 (and the dashboard 302), for example. The second dashboard data 308 and the first dashboard data 306 may be other questions for which the visual 304 can provide an answer, for example. The dashboard data engine 202 can retrieve dashboard data for other visuals of the dashboard 302, such as a visual 314, a visual 316, and possibly other visuals.

Referring again to FIG. 2, an embeddings generator 204 can generate word embeddings for all or a portion of words in textual data for each set of dashboard textual data obtained or generated by the dashboard data engine 202. The embeddings generator 204 can generate word embeddings for non-stopwords included in textual data for a dashboard, for example. Stopwords can include common words of a language, such as “a”, “the”, “is”, etc., that generally don't add specific value or meaning to the textual data. The embeddings generator 204 can translate non-stop words of dashboard textual data into an N-dimensional (e.g., 100-dimensional) numerical representation of the underlying text. For example, dashboard textual data can be represented by the embeddings generator 204 as a word embedding with a vector that has a length N. For example, the embeddings generator 204 can use a model (e.g., word2vec algorithms) that has been trained on existing textual items to obtain a mapping between text and vector space, and thus represent the dashboard textual data as a word embedding. The embeddings generator 204 can generate embeddings such that words that appear closer in the N-dimensional space are closer in semantic meaning than words that appear farther apart in the N-dimensional space. Word embeddings are described in more detail below with respect to FIG. 5.

The word embeddings of dashboard data generated by the embeddings generator 204 can be used by a search result generator 206 to generate search results in response to a dashboard search query received by the dashboard search engine 200. The search result generator 206 can remove stop words from the dashboard search query. The search result generator 206 can use the embeddings generator 204 to generate search query word embeddings (e.g., in the same N-dimensional space) for each non stopword included in the dashboard search query.

The search result generator 206 can use a comparison engine 208 to compare dashboard data 122 to the dashboard search query, based on the dashboard data word embeddings and the search query word embeddings. For example, the comparison engine 208 can compare, for each dashboard for which dashboard data 122 has been obtained, each set of textual data for the dashboard to the dashboard search query. For instance, the comparison engine 208 can use a distance determiner 210 that uses, for example, a word-mover distance algorithm to calculate a distance in the N-dimensional space between word embeddings of two respective words. A word-mover distance between a first word and a second word can represent a distance that a word embedding for the first word would need to travel in the N-dimensional space to be converted to a word embedding for the second word. A smaller word-mover distance between words indicates a greater similarity between the words and a greater word-mover distance between words indicates a lesser similarity between words.

The distance determiner 210 can use different distance metrics to calculate a word-mover distance between words. For instance, the distance determiner 210 can use a Euclidean distance metric, a Manhattan distance metric, or some other type of distance metric. A Euclidean distance can be calculated as the square root of the sum of the squared differences between two word vectors, for example. A Manhattan distance can be calculated as the sum of the absolute differences between two word vectors.

To compare, for a given dashboard, a first set of textual data for the dashboard to the dashboard search query, the comparison engine 208 can use the distance determiner 210 to calculate a distance between each word in the first set of textual data to each word in the dashboard search query. That is, the comparison engine 208 can use the distance determiner 210 to calculate a word-mover distance between each word pair combination between the first set of textual data and the dashboard search query. The comparison engine 208 can calculate a dashboard-text similarity score for the first set of textual data by adding together each distance of each word pair determined for the first set of textual data and the dashboard search query. A smaller dashboard-text similarity score for a set of textual data can indicate a greater similarity between the set of textual data and the dashboard search query and a greater dashboard-text similarity score for a set of textual data can indicate a lesser similarity between the set of textual data and the dashboard search query.

As an example, after stopword removal, if the first set of textual data for a first dashboard includes words of “dashboard1Text1Word1”, “dashboard1Text1Word2”, and “dashboard1Text1Word3” and the dashboard search query includes query words of “query Word1”, “query Word2”, and “query Word3”, the comparison engine 208 can use the distance determiner 210 to calculate word-mover distances d1, d2, d3, d4, d5, d6, d7, d8, and d9 that represent distances between “dashboard1Text1Word1” and “queryWord1”, “dashboard1Text1Word1” and “queryWord2”, “dashboard1Text1Word1” and “query Word3”, “dashboard1Text1Word2” and “query Word1”, “dashboard1Text1Word2” and “query Word2”, “dashboard1Text1Word2” and “query Word3”, “dashboard1Text1Word3” and “query Word1”, “dashboard1Text1Word3” and “queryWord2”, and “dashboardText1Word3” and “queryWord3”, respectively. A dashboard-text similarity score for the first set of textual data for the first dashboard (e.g., for “dashboard1Text1”) can be the sum of d1, d2 . . . d9. Other types of calculations can be performed, based on distance measures, to determine the dashboard-text similarity score for the first set of textual data for the first dashboard. For example, in some implementations, the dashboard-text similarity score can be calculated as the average of d1, d2 . . . d9. Although this example has a same number of words (after stopword removal) in the search query and the dashboard text, similar processing can occur when the strings have an unequal number of words (e.g., possible word pairings between words of the search query and the dashboard text can be identified, and a distance metric can be determined for each word pairing).

In some implementations, words that are common between the first set of textual data and the search query are withheld from distance calculations (e.g., since equal words have a word-mover distance of zero which would not contribute to a positive value to the similarity score). In some implementations, if the search query has a word that appears more than once, a weight can be applied to a distance value that corresponds to the word frequency (e.g., rather than separately calculate distance values for separate occurrences of the same search term).

As mentioned, the dashboard data engine 202 may have obtained multiple sets of textual data for a dashboard (e.g., one or more sets of textual data for each visual included in the dashboard). The comparison engine 208 can determine a dashboard-text similarity score for each set of textual data of each dashboard. For example, using a pattern established for the example above, the comparison engine can determine dashboard-text similarity scores for “dashboard1Text2”, “dashboard1Text3”, “dashboard2Text1”, “dashboard2Text2”, etc.

In some implementations, a dashboard similarity score can be determined for a query for each dashboard based on dashboard-text similarity scores of respective sets of dashboard text associated with the dashboard. A dashboard similarity score may be, for example, for each dashboard for which dashboard data 122 has been obtained, a smallest dashboard-text similarity score associated with the dashboard.

The search result generator 206 can generate search results for the dashboard search query based on dashboard similarity scores. For example, the search result generator 206 can rank dashboards based on dashboard similarity scores. The search result generator 206 can determine a count of search results to include in response to the dashboard search query. For instance, the search result generator 206 can identify a predetermined count M (e.g., five, seven, ten) of search results to include and determine, as dashboard search results, the M most-similar dashboards to the dashboard search query (e.g., dashboards having the M smallest dashboard similarity scores). The search result generator 206 can generate search result information for each dashboard search result, as described below with respect to FIG. 4.

FIG. 4 illustrates an example dashboard search engine user interface 400. The dashboard search engine user interface 400 can be provided by the dashboard search engine 106, for example, and provided for display on the client device 102 in, as, or as part of the dashboard application 110. The dashboard search engine user interface 400 includes a search area 402 and a search results area 404. The search area 402 includes a search box 406 that enables a user to enter a dashboard search query and a search button 408 that enables the user to initiate a search for dashboards that match and/or are identified in response to the dashboard search query. For example, a search query 410 of “How did our advisors do in August” has been entered in the search box 406. The search query 410 can be provided to the dashboard search engine 106 in response to user selection of the search button 408 (or in response to some other input such as selection of an enter key).

In response to receiving the search query 410, the dashboard search engine 106 can generate search results that include dashboard information for dashboards that match and/or are identified in response to the search query 410, as described above with respect to FIGS. 1-4. For example, the search results area 404 displays information for dashboards that match and/or have been identified in response to the search query 410. A summary area 412 includes a time-elapsed (to generate search results) statistic 414 (e.g., 1.9 seconds) and a search results count 416 (e.g., seven results).

Dashboard information for respective dashboard search results is displayed below the summary area 412. For example, the search results area 404 includes information for a first dashboard with a dashboard name 418 of “advisor overview”. For example, along with the dashboard name 418, the search results area 404 includes, for the first dashboard, a first dashboard image 420 and a first link 422 that enables launching of the first dashboard. In some implementations, a dashboard description (e.g., a one-sentence description provided by the dashboard developer) can also be included for the first dashboard in the search results area 404. Similarly, the search results area 404 includes information for a second dashboard with a dashboard name 424 of “advisor referrals”. The information for the second dashboard includes a second dashboard image 426 and a second link 428 that enables launching of the second dashboard. The search results area 404 includes a third dashboard name 430 of “advisor performance” for a third dashboard and a partial image 432 of the third dashboard. The user can scroll the dashboard search engine user interface 400 to view the remainder of the dashboard information for the third dashboard and for the remaining dashboards included in the search results.

The user can provide feedback for the search results using feedback controls 434 and 436. The feedback controls 434 and 436 can be graphic images (e.g., happy/sad faces, thumbs-up/thumbs-down images), as shown. As another example, feedback controls can enable a user to provide a ranking that is within a ranking range (e.g., a ranking from one to five). The feedback controls 434 and 436 are shown as enabling the user to provide feedback on the entire set of search results, but in some implementations, feedback controls can enable the user, alternatively or additionally, to provide feedback on individual search results.

FIG. 5 is a diagram 500 that illustrates aspects of an example word mover distance algorithm. The diagram 500 includes a graph 502 that represents a multi-dimensional space for representing word embeddings of words in a dashboard search query 504 and a set of dashboard textual data 506. The multi-dimensional space, although shown as a 3-dimensional space, can include any number of dimensions (e.g., 100 dimensions). Although stopwords 508, 510, and 512 (e.g., “the”, “is”, “of”, respectively) are shown as being plotted in the graph 502 for illustrative purposes, in practice, stopwords can be removed from respective text strings before word-mover distance calculations are performed. Removal of stopwords before word-mover distance calculations are performed can result in resource savings (as compared to generating word-mover distance calculations involving stopwords), without sacrificing search result accuracy.

The graph 502 shows a plotting of words of the dashboard search query 504 as word embeddings in the N-dimensional space. For example, points 514 and 516 are points in the N-dimensional space for “channels” 518 and “proportion” 520 words in the dashboard search query 504. Similarly, points 522 and 524 are points in the N-dimensional space for “month” 526 and “average” 528 words in the set of dashboard textual data 506. Although not all shown in the graph 502, the N-dimensional space can include points for each word in the dashboard search query 504 and the set of dashboard textual data 506.

As described above, as part of calculating a similarity score between the dashboard search query 504 and the set of dashboard textual data 506, a distance value can be calculated between each word pair combination of words between the dashboard search query 504 and the set of dashboard textual data 506. For example, an arrow 530 represents a word-mover distance between the “proportion” word 520 in the dashboard search query 504 and the “average” word 524 in the set of dashboard textual data 506 and an arrow 531 represents a word-mover distance between the “channels” word 518 in the dashboard search query 504 and the “average” word 524 in the set of dashboard textual data 506. As described above, in some implementations, for a word such as “what” 532 that appears in both the dashboard search query 504 and the set of dashboard textual data 506, distance values are not determined.

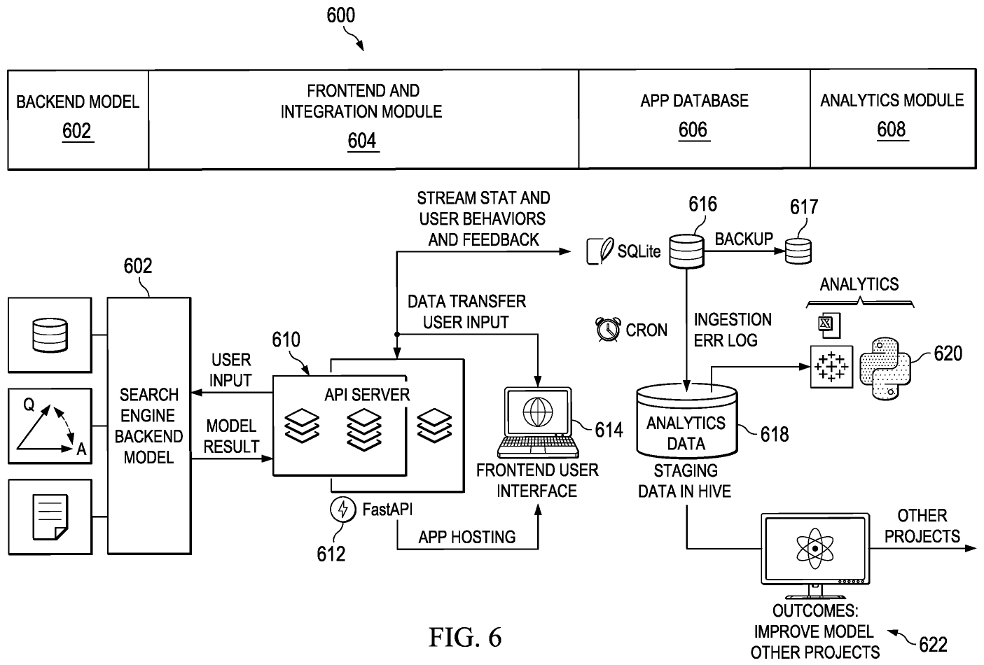

FIG. 6 illustrates an example dashboard search engine 600. The dashboard search engine 600 includes a backend model layer 602, a frontend and integration layer 604, an application database layer 606, and an analytics layer 608. The backend model layer 602 includes a search engine backend model 602. Development of the search engine backend model 602 can include development and training of the dashboard data engine 202, the embeddings generator 204, search result generator 206, the comparison engine 208 and the distance determiner 210, as described above with respect to FIG. 2. For instance, backend model development can include development of word embedding and word distance algorithms, including evaluation and selection of distance metrics. Backend model development can also include training of AI models, such as an AI model used by the dashboard data engine 202 for generating dashboard data for dashboard visuals.

The frontend and integration layer 604 can include an API (Application Programming Interface) server 610 that can provide an API 612. The API server 610 can be a host for a frontend user interface 614 that can receive, for example, user input such as a dashboard search query. The frontend user interface 614 can be the user interface 400 of FIG. 4 and/or the dashboard application 110 of FIG. 1, for example. The frontend user interface 614 can invoke the API 612 to request that the API server 610 forward search query input to the search engine backend model 602. The search engine backend model 602 can generate search results and provide search result information to the API server 610. The API server 610 can forward search result information to the frontend user interface 614, for presentation of search results.

The frontend user interface 614 can receive user input relating to presented search results, such as search result selection or other search result interaction, such as search result feedback. Search result interaction/feedback in the frontend user interface 614 can result in the frontend user interface 614 invoking the API 612, to request storage of search result interaction/feedback information in an application database 616 of the application database layer 606. Application data can be periodically backed up to a backup database 617.

Additionally, in some implementations, application data in the application database 616 is periodically (e.g., nightly) uploaded to an analytics database 618, for enablement of analytics in the analytics layer 608 using one or more analytics tools 620. The analytics tools 620 can perform analysis of data in the analytics database 618 to determine analytical outcomes 622, such as accuracy of the search engine backend model 602, search trends, server performance and user experience, etc. The analytical outcomes 622 can be used (e.g., by developers) to improve model accuracy of the search engine backend model 602 or to improve the frontend user interface 614 based on user feedback. Additionally, the analytical outcomes 622 can be provided as input to other projects or systems.

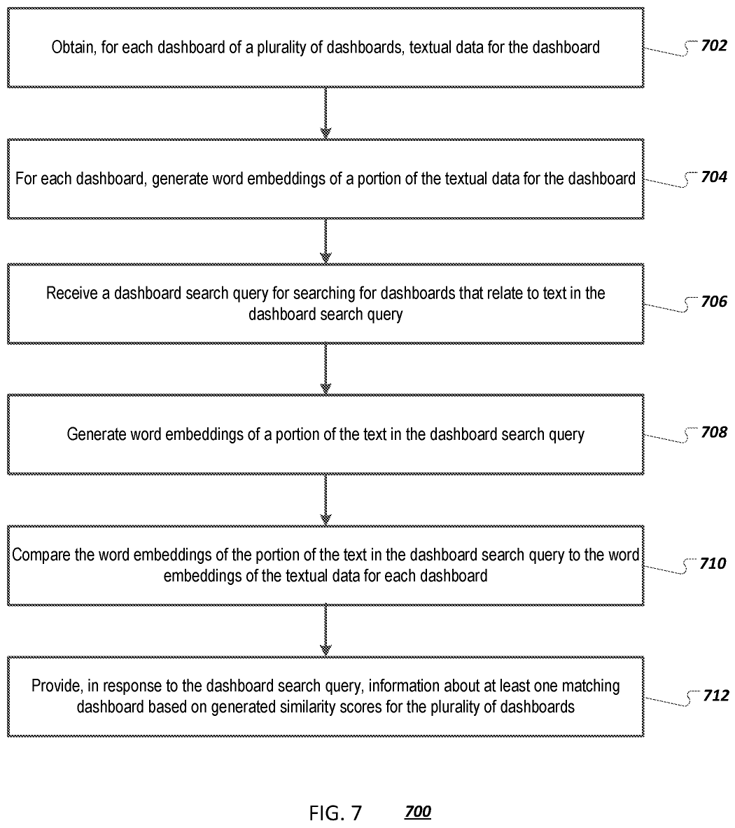

FIG. 7 is a flow diagram of an example method 700 for generating and providing dashboard search results. It should be understood that method 700 can be performed, for example, by any suitable system, environment, software, and hardware, or a combination of systems, environments, software, and hardware as appropriate. In some instances, method 700 can be performed by a system including one or more components of the environment 100, including, among others, the dashboard search engine 106 or the dashboard search engine 200 or portions thereof, described in FIG. 1 and FIG. 2, respectively, as well as other components or functionality described in other portions of this description. Any suitable system(s), architecture(s), or application(s) can be used to perform the illustrated operations.

At 702, as described with reference to FIGS. 1-6, the dashboard data engine 202 obtains for each dashboard of a plurality of dashboards, textual data for the dashboard. The textual data obtained by the dashboard data engine 202 for a dashboard can be metadata for the dashboard. The textual data obtained by the dashboard data engine 202 for a dashboard can be user-provided content regarding at least one visual included in the dashboard. User-provided content for a visual of a dashboard can be a natural language question that encapsulates content of the visual.

At 704, as described with reference to FIGS. 1-6, the embeddings generator 204, generates, for each dashboard, word embeddings of a portion of the textual data for the dashboard. In some implementations, stop words are removed from the textual data for a dashboard before generating word embeddings of the remaining portion of the textual data for the dashboard.

At 706, as described with reference to FIGS. 1-6, the dashboard search engine 106 receives a dashboard search query for searching for dashboards that relate to text in the dashboard search query.

At 708, as described with reference to FIGS. 1-6, the embeddings generator 204 generates word embeddings of a portion of the text in the dashboard search query. In some implementations, stop words are removed from the dashboard search query before generating word embeddings of the remaining portion of the text in the dashboard search query.

At 710, as described with reference to FIGS. 1-6, the comparison engine 208 compares the word embeddings of the portion of the text in the dashboard search query to the word embeddings of the textual data for each dashboard to generate a respective similarity score for each dashboard representing a degree of match between the word embeddings of the portion of the textual data for the dashboard and the word embeddings of the portion of the text in the dashboard search query.

The similarity score for a dashboard can be based on a determined distance determined by the distance determiner 210 in a vector space between word embeddings of words of the search query and word embeddings of words in the textual data for the dashboard. The distance determined by the distance determiner 210 between a word embedding of a search query word and a word embedding of a word in the textual data for a dashboard can represent a distance in the vector space between the word embedding for the word in the textual data for the dashboard and the word embedding of the search query word. The distance determiner 210 can determine distances using a word mover distance algorithm. The word mover distance algorithm can be based on a Euclidean distance metric, a Manhattan distance metric, or some other type of distance metric.

The comparison engine 208 can aggregate determined distances between word embeddings of words of the search query and word embeddings of the textual data of the at least one matching (or identified) dashboard. For example, a similarity score for textual data for a dashboard can be a sum of the distance metrics of word pair combinations of words in the textual data and words in the search query. As another example, a similarity score for textual data for a dashboard can be an average of the distance metrics of word pair combinations of words in the textual data and words in the search query. In some implementations, multiple sets of textual data can be obtained for the dashboard. For example, one or more sets of textual data can be obtained for each visual of the dashboard. A textual-data similarity score can be determined for each set of textual data of the dashboard. A dashboard similarity score for a dashboard can determined by determining a textual-data similarity score of textual data of the dashboard that is most similar to the search query among the multiple sets of textual data for the dashboard.

At 712, as described with reference to FIGS. 1-6, the dashboard search engine 106 provides, in response to the dashboard search query, information about at least one matching (or identified) dashboard based on the generated similarity scores for the plurality of dashboards. For example, the dashboard search engine 106 can rank dashboards based on similarity scores and provide information in response to the dashboard search query about a set of most-similar dashboards. In some cases, the information about the most-similar dashboards is included by the dashboard search engine 106 in a search results document and the search results document is provided by the dashboard search engine 106 in response to the dashboard search query. In some cases, the dashboard search engine 106 includes, in the search results document, a link for each dashboard includes in the search results, that when selected, provides access to the dashboard.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining, for each dashboard of a plurality of dashboards, textual data for the dashboard;
for each dashboard, generating word embeddings of a portion of the textual data for the dashboard;
receiving a dashboard search query for searching for dashboards that relate to text in the dashboard search query;
generating word embeddings of a portion of the text in the dashboard search query;
comparing the word embeddings of the portion of the text in the dashboard search query to the word embeddings of the textual data for each dashboard to generate a respective similarity score for each dashboard representing a degree of match between the word embeddings of the portion of the textual data for the dashboard and the word embeddings of the portion of the text in the dashboard search query; and
providing, in response to the dashboard search query, information about at least one matching dashboard based on the generated similarity scores for the plurality of dashboards.

2. The computer-implemented method of claim 1, wherein the similarity score for a dashboard is based on a determined distance in a vector space between word embeddings of words of the search query and word embeddings of words in the textual data for the dashboard.

3. The computer-implemented method of claim 2, wherein the information about the at least one matching dashboard is provided based on aggregate determined distances between word embeddings of words of the search query and word embeddings of the textual data of the at least one matching dashboard.

4. The computer-implemented method of claim 3, wherein the distance between a word embedding of a search query word and a word embedding of a word in the textual data for a dashboard represents a distance in the vector space between the word embedding for the word in the textual data for the dashboard and the word embedding of the search query word.

5. The computer-implemented method of claim 4, wherein the distance is a distance determined using a word mover distance algorithm.

6. The computer-implemented method of claim 5, wherein the word mover distance algorithm uses a Euclidean distance metric.

7. The computer-implemented method of claim 5, wherein the word mover distance algorithm uses a Manhattan distance metric.

8. The computer-implemented method of claim 1, wherein the textual data for a first dashboard comprises metadata for the first dashboard.

9. The computer-implemented method of claim 1, wherein the textual data for a first dashboard comprises user-provided content regarding at least one visual included in the first dashboard.

10. The computer-implemented method of claim 9, wherein the user-provided content for a first visual of the first dashboard comprises a natural language question that encapsulates content of the first visual.

11. The computer-implemented method of claim 1, further comprising removing stop words from the dashboard search query before generating word embeddings of the portion of the text in the dashboard search query.

12. The computer-implemented method of claim 1, further comprising removing stop words from the textual data of a first dashboard before generating word embeddings of the portion of the textual data of the first dashboard.

13. The computer-implemented method of claim 1, wherein providing information about at least one matching dashboard based on the similarity scores of respective dashboards comprises ranking dashboards based on similarity scores and providing information about a set of highest-ranked dashboards.

14. The computer-implemented method of claim 1, wherein providing information about a first matching dashboard comprises providing a link, that when selected, provides access to the first matching dashboard.

15. A system comprising:
at least one memory storing instructions;
a network interface; and
at least one hardware processor interoperably coupled with the network interface and the at least one memory, wherein execution of the instructions by the at least one hardware processor causes performance of operations comprising:
obtaining, for each dashboard of a plurality of dashboards, textual data for the dashboard;
for each dashboard, generating word embeddings of a portion of the textual data for the dashboard;
receiving, via the network interface, a dashboard search query for searching for dashboards that relate to text in the dashboard search query;
generating word embeddings of a portion of the text in the dashboard search query;
comparing the word embeddings of the portion of the text in the dashboard search query to the word embeddings of the textual data for each dashboard to generate a respective similarity score for each dashboard representing a degree of match between the word embeddings of the portion of the textual data for the dashboard and the word embeddings of the portion of the text in the dashboard search query; and
providing, via the network interface and in response to the dashboard search query, information about at least one matching dashboard based on the generated similarity scores for the plurality of dashboards.

16. The system of claim 15, wherein the similarity score for a dashboard is based on a determined distance in a vector space between word embeddings of words of the search query and word embeddings of words in the textual data for the dashboard.

17. The system of claim 16, wherein the information about the at least one matching dashboard is provided based on aggregate determined distances between word embeddings of words of the search query and word embeddings of the textual data of the at least one matching dashboard.

18. A non-transitory, computer-readable medium storing computer-readable instructions, that upon execution by at least one hardware processor, cause performance of operations, comprising:
obtaining, for each dashboard of a plurality of dashboards, textual data for the dashboard;
for each dashboard, generating word embeddings of a portion of the textual data for the dashboard;
receiving a dashboard search query for searching for dashboards that relate to text in the dashboard search query;
generating word embeddings of a portion of the text in the dashboard search query;
comparing the word embeddings of the portion of the text in the dashboard search query to the word embeddings of the textual data for each dashboard to generate a respective similarity score for each dashboard representing a degree of match between the word embeddings of the portion of the textual data for the dashboard and the word embeddings of the portion of the text in the dashboard search query; and
providing, in response to the dashboard search query, information about at least one matching dashboard based on the generated similarity scores for the plurality of dashboards.

19. The computer-readable medium of claim 18, wherein the similarity score for a dashboard is based on a determined distance in a vector space between word embeddings of words of the search query and word embeddings of words in the textual data for the dashboard.

20. The computer-readable medium of claim 19, wherein the information about the at least one matching dashboard is provided based on aggregate determined distances between word embeddings of words of the search query and word embeddings of the textual data of the at least one matching dashboard.
